(19) United States
(12) Patent Application Publication
(10) Pub. No.: US 2011/0309559 A1
(43) Pub. Date: Dec. 22, 2011

(54) Shaping and dimensioning of plant material containing cellulose

(76) Inventors: Dietmar Franke, Bayreuth (DE); Gerald Schmekel, Elmshorn (DE); Frank Plueckhahn, Bayreuth (DE)

(21) Appl. No.: 13/139,831

(22) PCT Filed: Nov. 16, 2009
(86) PCT No.: PCT/EP2009/065191

§ 371 Date: Sep. 7, 2011

(30) Foreign Application Priority Data
Dec. 18, 2008 (DE) 10 2008 063 613.4

(51) Int. Cl. B29C 47/76

(52) U.S. Cl. 264/571

(57) ABSTRACT

The invention relates to a method for shaping and dimensioning plant material containing cellulose, according to which the plant material is prepared by at least one extrusion process involving a compression by means of a pressure and temperature increase as well as mechanical processing of the material at an outlet of an extruder (1). The invention also relates to the use of an extrusion process involving a compression by means of a pressure and temperature increase as well as mechanical processing of the material at an outlet of an extruder (1) for preparing plant material containing cellulose and for shaping and dimensioning said material and to the use of a screw conveyor (1) with a screw clearance for preparing plant material containing cellulose and for shaping and dimensioning the plant material.

The present invention relates to a method for shaping and sizing cellulosic plant material. In particular, it relates to processing plant materials in order to manufacture food products and natural stimulants from “plant material scraps” which cannot be marketed or only with a loss of added value and which inevitably occur as a by-product in all processing steps in the food and natural stimulants industry. “Material scraps” refers to cellulosic plant materials which in the treatment chain do not occur in the desired particle shape, particle size or quality in terms of the specific marketing of the plant material. “Material scraps” also occur due to logistics operations (transport, intermediate storage, etc.) and customisation (cutting, breaking, etc.).

The utilisation value of cellulosic plant materials often depends not only on their materiality (chemistry) but also on their structure, expressed by geometric variables. This includes for example their behaviour when extractively used, their digestibility in the gastro-intestinal tract, their intensity of flavour, etc.

In view of their economic significance, different attempts have been made to solve such problems. Common to all the proposals is the aim of structuring within a given range of tolerance as a form of process preparation.

Examples with respect to structuring cellulosic plant materials include the known processes of manufacturing tobacco films from aqueous-phase small parts or also dry-phase pelleting methods. In hop technology, for example, not only waste but also entire umbels are pelleted in order to have more consistent properties for manufacturing beer.

Unfortunately, it has often enough emerged that allowed but undesirable added ingredients have to be added as additives/process aids (binders, aroma enhancers, aroma agents, preservatives) and that only multi-stage processes can achieve the aim. “Multi-stage processes” is understood to mean procedures involving elaborate upstreaming and downstreaming; this includes grinding processes, sifting, sieving, drying and conditioning.

The disclosures in documents DE 10 2004 059 388 A1 and DE 10 2005 006 117 A1—restricted to the field of tobacco processing—have addressed solving these problems.

It is the object of the present invention to enable cellulosic plant materials to be optimally structured.

This object is solved in accordance with the invention by a method in accordance with claim 1. The invention also includes uses in accordance with the corresponding co-ordinated claims. The sub-claims describe advantageous embodiments of the invention.

In accordance with the invention, a method for shaping and sizing cellulosic plant material is disclosed in which the plant material is treated in at least one extrusion process which includes compressing by means of an increase in pressure and temperature and mechanically processing the material at an outlet of an extruder.

The invention is based among other things on the realisation that so-called “industrial waste products” are generally not lower-quality materials but that their utilisation value is merely confined by the geometry of their particles which is not suitable for market application. It is not for example possible to use tea dust directly for drinking by extracting the constituents using water, as for example in tea strainers. By shaping and sizing the particles suitably and in accordance with the invention, however, it is possible to again increase the utilisation/conversion of raw material and therefore the yield, i.e. in accordance with the object, particles are altered (increased or decreased in size) in order to structure them in a way which is acceptable in terms of subsequent use.

Advantageously, the present invention also allows thermally sensitive materials to be processed. Steam-volatile aroma constituents can be retained in the extrudate through corresponding process conditions, for example by controlled or minimised and/or suppressed flash vaporisation at the extruder outlet.

Conversely, instantaneous-decompression drying as performed in one embodiment of the method can be helpful in forming voluminous, fibrous products.

Preferably, additional and/or external binders are not added to the plant material in order to bind small parts of plant material to each other or to larger parts, i.e. extrusion in accordance with the invention allows an additive-free treatment by activating the binding capacity of the molecular structures while retaining the flavour carriers.

In accordance with this embodiment of the present invention, the material which is to be processed—which comprises small parts (including dust) and larger parts—is exposed to an increased mechanical pressure and in particular also to increased temperature and moisture, in order to adhere the small parts remaining to the larger material. In other words, the smaller parts including the dust are connected to the larger parts to form one entity, in order to then subsequently be able to directly and normally use the material with the small parts bound to it. This avoids any elaborate separate processing. The small parts are simply already adhered to a material and/or connected to the material which is in any case subsequently used normally.

This measure achieves a significant shift in the size distribution towards larger particles, particularly in the target size range of 1 to 4 mm. This can be evidenced by sieve analyses before and after the treatment in accordance with the invention. Where “small parts” are mentioned within the framework of the present description, this refers in particular to small parts which are actually regarded as disadvantageous (including in terms of flavour) and are otherwise merely suctioned away. Small parts are in particular smaller than 1 mm and even more specifically smaller than 0.5 mm.

The larger material to be processed and the small parts can be set to a predetermined moisture within the framework of the present invention. It is also possible to expose the material to be processed to an increase in temperature which can result from supplying external heat and/or generating mechanical pressure. The advantages of this embodiment of the method in accordance with the invention are thus based in particular on the fact that larger material parts, together with small parts, are exposed to a mechanical pressure (for example in an extruder or conveying screw conditioner) at an increased temperature and defined moisture. The mechanical pressure presses the small parts onto the larger material and connects them homogenously to it. Due to the method conditions in accordance with the invention, the connection is strong enough that the material treated in accordance with the invention is resistant to the normal stresses during manufacture and use. In this method, the material to be processed can comprise an amount of small parts which corresponds to its processing state; it can, however, also comprise more than such an amount of small parts, in particular an amount which is increased by adding small parts, which would not only ensure that the small parts already occurring are processed but could also additionally enable small parts to be processed which have been created at other points in the production, in particular including dust.

In accordance with this aspect of the invention, it is thus not necessary to add additional and/or external binders for binding the small parts to the larger material: neither binders which are foreign to the material nor inherent binders, i.e. binders which are naturally present in the material. Instead, it is possible to bind the small parts to the larger material mechanically and/or with the amounts of binder (inherent binders) which are naturally present in the material. The method conditions in accordance with the invention activate such inherent binders (starch, resins, sugar, etc.) and so fix the small parts to the larger material.

Also disclosed is the realisation that the process in accordance with the invention can be substantially embodied cost-effectively in one stage and can be performed in the absence of oxygen.

If there are no process temperature restrictions which have to be observed, the extrusion process can be embodied to be sterilising. Surprisingly, it has emerged that the “customisation” in accordance with one embodiment of the invention can be solved by specialised extrusions with integrated conditioning.

In order to be able to apply the method of the invention in a particularly successful way, formulas of texturising and flavourant raw materials are particularly advantageous. Suitable texturising materials include for example fractions of cereals, such as: wheat, maize, oat and soya bran; wheat fibre meal, pea fibre meal; oat flakes, barley flakes and fractions of natural stimulant plants such as tea stem particles which exhibit a high fibrous content (cellulose).

“Flavourant materials” is to be understood to mean the corresponding food starches or “leaf fractions”. Through process activation, amylaceous materials can also influence the density of the end product in a controlled way, if this property is relevant to the consumer utilisation value.

Herb and spice fractions can also in advantageously be treated using the customisation method; clove waste and hops may be mentioned as representatives of this group. Clove waste can be reconstituted by the extrusion method and processed in a mixture with cut tobacco to form kreteks. “Kretek” refers to Indonesian cigarettes which preferably contain up to 50% clove material and are manufactured and consumed in their billions. The treatment of clove materials using this method is particularly economic due to the price per kilo.

The processing unit used can be an extrusion module comprising an arrangement which includes the following components:
batch assembly in a mixing silo in order to constitute the formula;
dosing by volume (mass) in a dosing screw;
treatment in the extruder, consisting of the steps of:
   conditioning with water/steam and as applicable casing (in a liquid and/or solid form);
   compressing, mixing, heating, dwelling, flavouring, aromatising;
   shaping fibres into a pile by decompression drying, while simultaneously restoring the natural filling capacity by expansion to ambient pressure;
cooling in order to fix the structure and extract adherent steam.

It is possible to influence the constituent values determined in hybrid products, i.e. depending on the chemical structure of the starting material. The fibrous form of the finished material opens up a wide range of new product solutions. The cellulosic plant material can be a non-tobacco material or can consist of a non-tobacco material to a substantial extent, in particular more than 10%, specifically more than 30%, in particular more than 50%.

The cellulosic plant starting material can primarily comprise a coarse material which in particular exhibits a particle size of more than 2 mm, and it is possible in accordance with the invention for the method to be performed without adding structuring materials.

The plant material to be processed can be exposed to an increase in temperature which results from supplying external heat and/or generating mechanical pressure, and can be a pre-conditioned material. The product which is created by processing the plant material to be processed is also preferably a non-continuous shaped material, in particular a fibrous material.

The invention also relates to the use of an extrusion process which includes compressing by means of an increase in pressure and temperature and mechanically processing the material at an outlet of an extruder, for treating cellulosic plant material in order to shape and size the plant material. All the method features described here—or also features of the devices disclosed—can of course be incorporated into the use in accordance with the invention. The invention also relates to the use of a filling screw extruder comprising a shearing gap outlet for treating cellulosic plant material in order to shape and size the plant material.

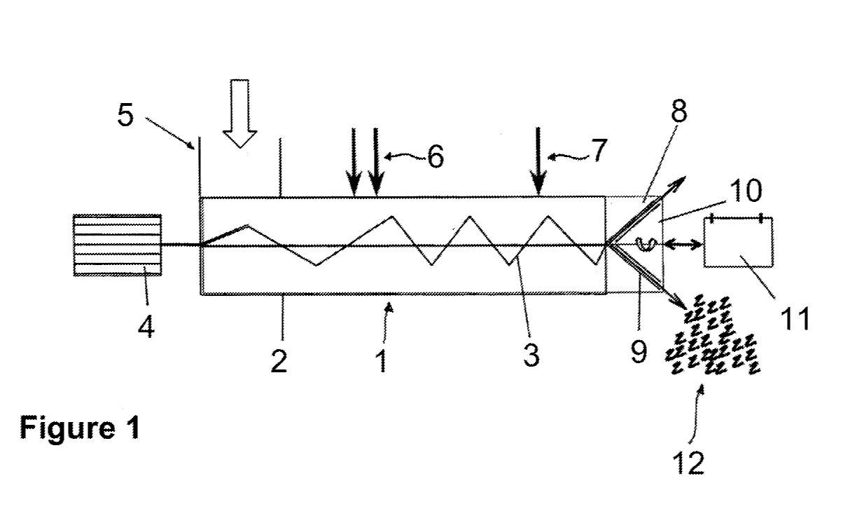

The invention is explained below in more detail on the basis of embodiments and by referring to the enclosed drawing. It can include any of the features described here, individually and in any expedient combination. The one enclosed FIGURE, FIG. 1, shows a device for structuring plant material by thermal extrusion.

The device which can be used in accordance with the invention, which is provided as a whole with the reference sign 1, comprises a chamber housing 2 and a conveying screw 3 which is provided in the chamber housing 2 and is rotated via the motor 4. The drawing in FIG. 1 also shows a plant material inlet 5 and optional inlets for conditioning agents, for example water and steam, which bear the reference signs 6 and 7. At the outlet end (on the right in the FIGURE), the chamber comprises a head 8 which forms an inner cone. The inner cone wall of the head 8 and the outer cone wall of the outer cone 10 together form the gap 9 through which the material conveyed by the screw 3 can escape. An opening to the interior of the chamber 2 is situated at the gap tip of the inner cone 8. The escaped restructured material is indicated by the reference sign 12.

The outer cone 10 is positioned by a counter bracket 11 which can simultaneously provide a rotary drive for the conical body 10. The cone 10 can be rotated about the central axis by means of this rotary drive, as shown by the curved arrow. The connection between the counter bracket 11 and the cone 10 is shown by a double-headed arrow, which signifies that the cone 10 can be moved onto the inner cone 8 on the axis, where it can be fixedly held in its axial position or also arranged such that it can be axially moved. By means of this design, the width of the gap can be set or adjusted, and a counter pressure is generated to the left, i.e. in the direction of closing the gap 9, preferably by hydraulic means.

The first part of processing is performed in accordance with the invention at superatmospheric pressure. This pressure burden is generated by conveying the material in the chamber 2 through the screw 3 after it has been inputted via the inlet 5. A shearing gap outlet is situated at the end of the conveying screw and almost seals the conveying space in a similar way to an extruder. This cavity outlet is preferably embodied as an annular gap, i.e. as a conical gap 9, the gap width of which can be set by the outer cone 10 (plunger). The material is thus exposed to an increased pressure (of up to 200 bars) and an increased temperature (of in particular significantly more than 100° C.). In addition to the mechanical pressure created by conveying the material towards said gap, additional forces operate because shearing forces act in the flights of the conveying screw in conjunction with the wall and pre-comminute and/or pre-defibrate the material. Shearing can be assisted by introducing entrainments into the housing wall or by introducing additional flow resistances. Steam can additionally be supplied at a number of points in order to regulate the moisture, temperature and pressure in the conveying screw and/or in the housing 2. The supplied steam and the inherent moisture of the material from conditioning cause additional defibration as the material exits the gap 9, because the water vaporises instantaneously. The pressurised moisture in the stems vaporises instantaneously after the annular gap as the pressure drops to atmospheric pressure; flash vaporisation occurs.

As it passes through the gap 9, the material is thus exposed to shearing between the gap walls, and as it exits the gap, the flash vaporisation already mentioned above occurs. The concurrence of these effects creates the very well structured method product, at least a large portion of which can even directly be used normally.

In order to prevent blockages from occurring at the narrow shearing gap 9 over a large region of the annular and/or conical area, which then suddenly detach again, it has proven helpful to keep the cone 10 rotating about its rotational axis. This rotation can be continuous or interrupted in one direction, or the rotational direction can change, wherein the rotation can be a complete rotation or can comprise only quarter turns or third turns or smaller/larger units. It has additionally proven advantageous if the surface of at least one of the cones—the inner cone on the head 8 or the outer cone on the plunger 10—is roughened or profiled, for example by introducing grooves or crossed grooves, specifically to a depth of 2 or 3 mm. What is important here is merely the roughening/profiling, the depth and course (direction) of the grooves can be set in any way. This, specifically in conjunction with the rotations of the cone 10, enables blockages to be significantly reduced. This provides more homogenous pressure conditions which also result in a more homogenous end product.

An example of the method in accordance with the invention, on the basis of extruding tea:

A method in accordance with the invention was tested in an extrusion facility on the basis of orange-flavoured rooibos tea. In this experiment, it emerged that an extrusion facility such as is described in documents DE 10 2004 059 388 A1 and DE 10 2005 006 117 A1 and shown in part in FIG. 1 can also be used as a processing facility for other cellulosic plant materials (for example, tea) or hybrid products (for example, tea/tobacco), although specialist circles have had to question this in principle because it had to be assumed that other plant materials would even in principle also require other process parameters and/or process embodiments. The following parameters were used and/or obtained:

| Starting | Variety: | Tea (orange-flavoured rooibos) | | |
|---|---|---|---|---|
| material: | Moisture: | 11.6% | | |
| | Particle size distribution: | >1 | mm | 3.2% |
| | | 1-0.5 | mm | 77.5% |
| | | 0.5-0.3 | mm | 14.6% |
| | | <0.3 | mm | 4.7% |
| Finished | Fibre thickness: | 0.5-1.5 | mm | |
| material: | Fibre length: | 5-30 | mm | |
| | Moisture: | 16% | | |
| Extrusion | Material throughput: | 100 | kg/h | |
| process | Extruder pressure: | 70 | bar | |
| parameters: | Extruder | 133° | C. | |
| | temperature: | | | |
| | Water throughput: | 22 | kg/h | |
| | Expander power | 11.5 | kW | |
| | rating: | | | |

The tea material obtained was capable of being brewed and remained stable in the process.

An example of the method in accordance with the invention, on the basis of extruding cloves:

Clove waste and tobacco winnowings were mixed in the facility in a ratio of 1:3 and without conditioning and were supplied to an extrusion process. They were extrusively structured using a rotating shearing gap with the aid of a profiled cone/seat assembly (see for example FIG. 1). The mass flow was set so as to enable a minimum extrusion temperature and as low an addition of water as possible to be set. These measures were intended to help minimise the loss or decomposition of the typical clove aroma (which is steam-volatile). Cigarettes were manufactured from the extrudate and presented to a test panel.

Surprisingly, the smoking sensation was described as being comparable to that of “conventional clove cigarettes (kreteks)” in terms of the aroma characteristics and with respect to the “crackling” when lit and smoked. These sounds which the consumer expects are generated by the “explosive combustion” of the clove constituents during the passage of embers and demonstrate the high aroma content of the product without analytical measurements.

The method enables the “crackling” to be augmented in the desired way by replacing winnowings with nitrate-rich Burley stems.

1. A method for shaping and sizing cellulosic plant material, wherein the cellulosic plant material is treated in at least one extrusion process which includes compressing by an increase in pressure and temperature and mechanically processing the material at an outlet of an extruder.

2. The method according to claim 1, wherein instantaneous-decompression drying is performed at the outlet of the extruder.

3. The method according to claim 1, wherein additional and external binders are not added to the cellulosic plant material in order to bind small parts of cellulosic plant material to at least one of each other and larger parts.

4. The method according to claim 1, wherein the at least one extrusion process is embodied substantially in one stage.

5. The method according to claim 1, wherein the extrusion process is performed in absence of oxygen.

6. The method according to claim 1, wherein the extrusion process is embodied to be sterilizing and is performed on the cellulosic plant material at sterilizing temperatures at least one processing point.

7. The method according to claim 1, wherein the cellulosic plant material is restructured by specialized extrusions with integrated conditioning, wherein the cellulosic plant material is set to a predetermined moisture.

8. The method according to claim 1, wherein formulas of texturizing and flavorant cellulosic plant materials are processed.

9. The method according to claim 1, wherein at least one of the following materials is processed:
texturizing materials comprising at least one of: fractions of cereals, such as wheat, maize, oat and soya bran; wheat fiber meal, pea fiber meal; oat flakes, barley flakes and fractions of natural stimulant plants which exhibit a high fibrous content, cellulose;
flavorant materials;
at least one of herb and spice fractions.

10. The method according to claim 1, wherein the cellulosic plant material is a non-tobacco material.

11. The method according to claim 1, wherein the cellulosic plant material primarily comprises a coarse material which exhibits a particle size of more than 2 mm.

12. The method according to claim 1, which is performed without adding structural materials.

13. The method according to claim 1, wherein the cellulosic plant material to be processed is exposed to an increase in temperature which results from at least one of supplying external heat and generating mechanical pressure.

14. The method according to claim 1, wherein the cellulosic plant material to be processed is a pre-conditioned material.

15. The method according to claim 1, wherein the cellulosic plant material to be processed is an irregularly shaped fibrous material wherein the processing of the cellulosic plant material forms a product.

16. An extrusion process comprising compressing by an increase in pressure and temperature and mechanically processing cellulosic plant material at an outlet of an extruder for treating cellulosic plant material in order to shape and size the cellulosic plant material.

17. (canceled)

18. The method of claim 1 wherein the extruder is filling screw extruder comprising a shearing gap outlet for treating cellulosic plant material for shaping and sizing the cellulosic plant material.

19. The method according to claim 1, wherein additional binders are not added to the cellulosic plant material in order to bind small parts of cellulosic plant material to at least one of each other and larger parts.

20. The method according to claim 1, wherein external binders are not added to the cellulosic plant material in order to bind small parts of cellulosic plant material to at least one of each other and larger parts.

21. The method of claim 9 wherein the fractions of natural stimulant plants include tea stem particles.

22. The method of claim 9 wherein the flavorant materials include food starches.

23. The method of claim 9 wherein the flavorant materials include leaf fractions.

24. The method of claim 9 wherein the herb and spice fractions include clove waste.

25. The method of claim 9 wherein the herb and spice fractions include hops.

26. The method according to claim 1, wherein the cellulosic plant material comprises at least 10% of a non-tobacco material.

27. The method according to claim 1, wherein the cellulosic plant material comprises at least 30% of a non-tobacco material.

28. The method according to claim 1, wherein the cellulosic plant material comprises at least 50% of a non-tobacco material.
